(19) United States
(12) Patent Application Publication
(10) Pub. No.: US 2014/0190316 A1
(43) Pub. Date: Jul. 10, 2014

(54) Magnetic oil drain plug apparatus and method of use

(71) Applicant: Charles Stebbins, Greenville, OH (US)

(72) Inventor: Charles Stebbins, Greenville, OH (US)

(21) Appl. No.: 14/150,911

(22) Filed: Jan. 9, 2014

Related U.S. Application Data
(60) Provisional application No. 61/751,214, filed on Jan. 10, 2013.

(51) Int. Cl. B25B 13/48; B25B 13/46; B25B 23/12

(52) U.S. Cl. CPC B25B 13/48; B25B 23/12; B25B 13/46
USPC 81/60; 29/426.2

(57) ABSTRACT

A magnetic oil drain plug removal apparatus is provided. After the drain plug has been loosened manually, the ratcheting mechanism, such as a wrench, would clamp or magnetically attach to the drain plug; the clamp or magnetic holder would then be rotated by the user to turn the screw via a thumb-actuated ratchet mechanism. Using the ratcheting mechanism, the user would then remove the drain plug from the oil pan without the risk of spilling oil on himself or herself, or dropping the drain plug into the hot oil that has drained out of the oil pan.

### CROSS-REFERENCE TO RELATED APPLICATIONS

This application claims priority to U.S. Provisional Application No. 61/751214, filed Jan. 10, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to oil drain plug removal apparatus, and in particular to a magnetic oil drain plug removal apparatus. Vehicle owners who perform their own oil changes, as well as professional vehicle service shops, face the problem of handling a hot oil drain plug and keeping track of it while the used oil drains out of the vehicle. The drain plug is too hot to be handled easily, and it retains heat for several minutes. But service technicians agree that the best time to change the oil is when the oil is hot, after the vehicle has been running for several minutes. The result is a risk of burned fingers, as well as dropping the drain plug into the drain pan full of hot, used oil. Making a magnetic apparatus that will safely secure the drain plug while it is being removed would prevent the risk of burns and the problem of searching around in the hot, dirty oil for the drain plug.

### SUMMARY OF THE INVENTION

Accordingly, the invention is directed to a magnetic oil drain plug removal apparatus. After the drain plug has been loosened manually, a ratcheting mechanism, such as a wrench, would clamp or magnetically attach to the drain plug; the clamp or magnetic holder would then be rotated by the user to turn the screw via a thumb-actuated ratchet mechanism. Using the ratcheting mechanism, the user could then remove the drain plug from the oil pan without the risk of spilling oil on himself or herself, or dropping the drain plug into the hot oil that has drained out of the oil pan. In this way, the user need not touch the drain plug or the hot used oil to complete an oil change.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

FIG. 1 shows the front view of the first exemplary embodiment displaying the tube 10, the magnetic turntable 11, the rod 12, and the ratchet mechanism 13.

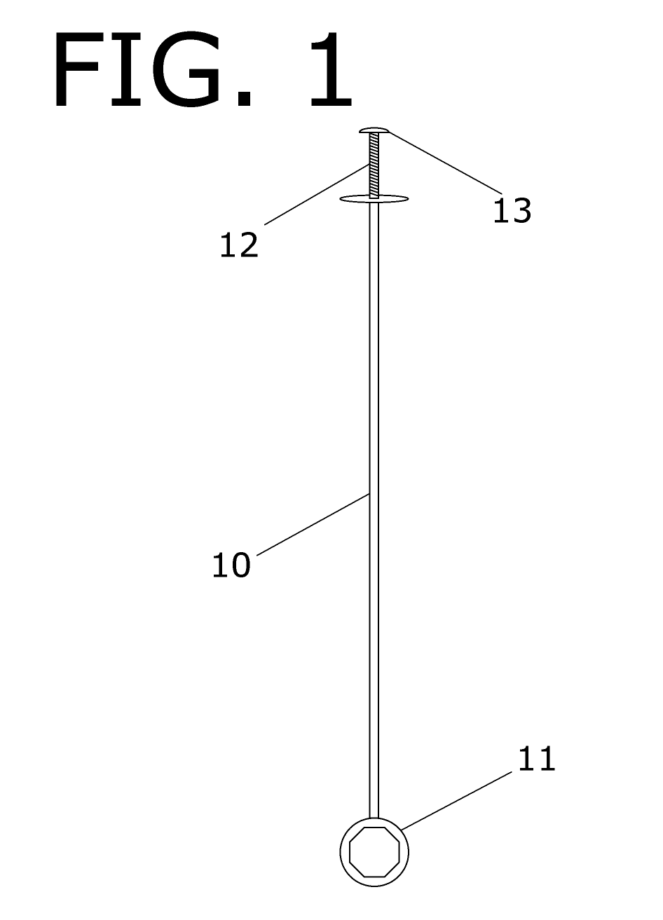

### DETAILED DESCRIPTION OF THE INVENTION

Referring now to the invention in more detail, the invention is directed to a magnetic oil drain plug removal apparatus. After the drain plug has been loosened manually, the magnetic turntable 11 would clamp or magnetically attach to the drain plug; the clamp or magnetic holder would then be rotated by the user to turn the screw via a thumb-actuated ratchet mechanism 13. Using the ratcheting mechanism 13, the user could then remove the drain plug from the oil pan without the risk of spilling oil on his hands, or dropping the drain plug into the hot oil that has drained out of the oil pan. In this way, the user need not touch the drain plug or the hot used oil to complete an oil change.

The tool preferably consists of a permanently magnetic turntable 11 permanently affixed by a weld or similar manufacturing process, to the end of a hollow flexible steel tube 10. The turning component of the turntable 11 is preferably shaped in a manner complementary to an oil drain plug nut for a vehicle. A rod 12 runs through the tube 10, and is activated by a thumb-actuated ratchet mechanism 13 permanently affixed at the other end of the rod 12, by a weld or similar manufacturing process. The rod 12 is configured such that axial force on the rod 12 provided through the thumb-actuated ratchet mechanism 13 will cause the turntable 11 to turn. The ratchet mechanism, 13 and rod 12 are further configured such that the rod 12 will be returned to its neutral position automatically upon the release of the ratchet mechanism 13 by the user. The user must first loosen the drain plug manually, for example with a wrench, about a half turn. Then the user attaches the magnetic turntable 11 to the drain plug and pushes the thumb plunger on the ratchet mechanism 13, unscrewing the drain plug. The drain plug can then be easily removed and the hot oil drained into a collection vessel.

To replace the oil plug and finish the oil change, the process is simply reversed. The turntable 11 is preferably accessible on both sides, and thus the direction of rotation may be inverted by inverting the oil drain plug and engaging it to the opposite side of the turntable.

The magnetic turntable 11 would be manufactured from high-carbon, tool grade steel and magnetized. The tube 10 and rod 12 would preferably be manufactured from a strong, durable, flexible material such as Flexsteel™. The ratchet mechanism 13 would preferably be manufactured from high-carbon, tool grade steel.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An oil drain plug removal tool comprising:
(a) a turntable;
(b) said turntable being shaped to conform to a vehicle oil drain plug;
(c) said turntable being permanently magnetic;
(d) a rod;
(e) a tube;
(f) said rod being disposed axially within said tube;
(g) said turntable being affixed to said tube at its end;
(h) said rod being configured such that axial compression upon said rod urges said turntable to rotate;
(i) a ratchet mechanism;
(j) said ratchet mechanism being affixed to said tube at its opposite end from said turntable; and
(k) said ratchet mechanism being configured to apply axial compression upon said rod when actuated by a user;
whereby said vehicle oil drain plug may be magnetically retained in said turntable while being urged into a closed or open position by the rotation thereof.

2. The oil drain plug removal tool of claim 1 wherein said rod and said tube are flexible.

3. A method of using the oil drain plug removal tool of claim 1 comprising:
(a) placing a collection vessel beneath the oil drain of a vehicle;
(b) manually loosening said vehicle oil drain plug about one half turn;
(c) engaging said turntable to said vehicle oil drain plug such that said vehicle oil drain plug is magnetically retained in said turntable and such that said turntable will rotate in a loosening direction;
(d) actuating said ratchet mechanism and thereby rotating said turntable until said vehicle oil drain plug is released;
(e) removing said oil drain plug removal tool with said vehicle oil drain plug thereattached from the vicinity of the oil drain of said vehicle;
(f) allowing oil to drain from the oil drain of said vehicle into said collection vessel;
(g) re-engaging said turntable to said vehicle oil drain plug such that said vehicle oil drain plug is magnetically retained in said turntable and such that said turntable will rotate in a tightening direction;
(h) returning said oil drain plug removal tool with said vehicle oil drain plug thereattached to the oil drain of said vehicle;
(i) actuating said ratchet mechanism and thereby rotating said turntable until said vehicle oil drain plug is engaged to the oil drain of said vehicle;
(j) disengaging said turntable from said vehicle oil drain plug; and
(k) manually tightening said vehicle oil drain plug.

4. The method of claim 2 wherein said rod and said tube are flexible.
